(19) United States
(12) Patent Application Publication
(10) Pub. No.: US 2003/0059195 A1
(43) Pub. Date: Mar. 27, 2003

(54) Optical devices using shaped optical fibers and methods for making optical devices with shaped optical fibers

(76) Inventors: James F. Brennan III, Austin, TX (US); Barbara A. DeBaun, Woodbury, MN (US); Barry J. Koch, Blaine, MN (US); Dwayne L. LaBrake, Cedar Park, TX (US); Nicholas A. Lee, Woodbury, MN (US); Michael R. Matthews, Austin, TX (US); Terry L. Smith, Roseville, MN (US); Wayne F. Varner, Woodbury, MN (US)

Correspondence Address: 3M INNOVATIVE PROPERTIES COMPANY, PO BOX 33427, ST. PAUL, MN, 55133-3427, US

(21) Appl. No.: 10/232,213

(22) Filed: Aug. 29, 2002

Related U.S. Application Data
(60) Provisional application No. 60/315,960, filed on Aug. 29, 2001.

(51) Int. Cl. G02B 6/00

(52) U.S. Cl. 385/146; 385/11

(57) ABSTRACT

Optical devices using shaped optical fibers and methods for using shaped optical fibers.

### CROSS-REFERENCE TO RELATED APPLICATIONS

This application is related to co-pending U.S. patent application Ser. Nos. 09/515,187 and 09/515,448, and claims priority to U.S. Provisional Application No. 60/315,960, filed Aug. 29, 2001.

### TECHNICAL FIELD

This invention relates to methods for making optical fiber devices using shaped optical fibers or optical fibers with multiple core regions. The fibers have shapes and/or surface features with a known orientation to a transverse axis of the fiber.

### BACKGROUND

To maintain or preserve the polarization properties of a signal in an optical fiber, the optical properties of the fiber may be made anisotropic. In highly birefringent single core optical fibers the waveguiding region formed by the cladding and core regions in the fiber define two transverse orthogonal axes, which permit the de-coupling of waves polarized along those axes. If a signal launched into these fibers has its polarization aligned with one of these transverse axes, the polarization tends to remain aligned with that axis as the signals are propagated though the fiber. This preserves the polarization of the signal. Highly birefringent optical fibers such as, for example, polarization maintaining (PM) and polarizing (PZ) fibers, require precise alignment of their transverse orthogonal axes when they are joined to other similar fibers, interfaced with other polarized sources or detectors, have a Bragg grating written into their core regions, or are treated during other manufacturing processes. Identification and alignment of the fiber's transverse axes requires a considerable amount of time and complex equipment. In addition, errors in locating the transverse axes cause poor performance in optical fiber devices using birefringent fibers.

In addition, whether birefringent or not, optical fibers may include features that are not rotationally symmetric. For example, to improve the coupling efficiency of a single mode or a PM/PZ optical fiber to an optoelectronic semiconductor device, the fiber may include a lensed tip. As a specific example, to achieve maximum coupling efficiency between an optical fiber and erbium-doped optical fiber preamplifier pump laser, the tip of the fiber may be fabricated with a wedge-shaped lens. Since such semiconductor devices emit an optical beam that is highly elliptical, there is inherent rotational angle dependence when coupling the output beam of the device into the wedge-shaped lens on the fiber tip. Therefore, to achieve maximum coupling efficiency, some means of rotational alignment is required between the relative angles of the emission ellipse and the wedge-face direction of the lens. Errors in this alignment procedure introduce variability into device coupling, and efforts to reduce and/or eliminate these alignment errors increase production costs.

### SUMMARY

U.S. patent application Ser. Nos. 09/515,187 and 09/515,448 describe birefringent optical fibers with an outer periphery that may be shaped to provide an alignment feature or an external rotational reference. The non-circular cross-sectional shape of the fiber, or features on the outer surface of the fiber, provide an easily visible, “passive” means of locating an internal region in the fiber, such as the fiber's transverse, orthogonal birefringent axes, or an external surface feature. This allows the fibers to be easily rotationally aligned with respect to a device while maintaining their internal regions or surface features in a known orientation with respect to the device.

The present invention is directed to optical devices using shaped fibers and methods for using them to make optical devices.

In one aspect, the invention is a method for sensitizing an optical fiber, including: (a) providing a section of a shaped optical fiber having a waveguiding region with a known internal geometry, wherein the waveguiding region is oriented at a known angle with respect to one of: (i) a portion of an outer surface of the fiber, and (ii) one or more features on the outer surface of the fiber; and (b) passing the fiber between a first electrode and a second electrode such that an electric field is applied to the waveguiding regions wherein at least one of the first and second electrodes have a feature that engages at least one of the portion of the outer surface of the fiber and the feature of the fiber to maintain the orientation of the waveguiding region of the optical fiber with respect to the applied electric field.

In a second aspect, the invention is a method for making an electric field sensor, including: (a) providing a shaped optical fiber having a waveguiding region with transverse axes, wherein the axes are oriented at a known angle with respect to one of: (i) a portion of an outer surface of the fiber, and (ii) one or more features on the outer surface of the fiber; (b) poling the fiber; and (c) wrapping the fiber about a cylindrical insulator, wherein an outer surface of the insulator includes a feature that engages at least one of the portion of the outer surface of the fiber and the feature of the fiber to maintain the orientation of the waveguiding region of the optical fiber with respect to an applied electric field, and (d), applying an electric field to the optical fiber to produce electro-optic axes exhibiting a phase difference in light transmitted through the optical fiber, wherein the phase difference has a known orientation with respect to the transverse axes of the fiber.

In a third aspect, the invention is a method for making an optical fiber Bragg grating, including providing an orientation device having a surface feature; inserting into the surface feature of the orientation device a shaped optical fiber having a waveguiding region with transverse axes, wherein the axes are oriented at a known angle with respect to one of: (i) a portion of an outer surface of the fiber, and (ii) one or more features on the outer surface of the fiber; and writing a Bragg grating in the waveguiding region at a known angle with respect to the transverse axes of the waveguiding region.

In a fourth aspect, the invention is a method for altering the birefringence of an optical fiber, including: (a) providing a shaped optical fiber having a waveguiding region with transverse axes, wherein the axes are oriented at a known angle with respect to one of: (i) a portion of an outer surface of the fiber, and (ii) one or more features on the outer surface of the fiber, (b) straining the optical fiber in a device having a surface with a feature that engages at least one of the portion of the outer surface of the fiber and the feature of the fiber to maintain the orientation of the waveguiding region of the fiber with respect to the device.

In a fifth aspect, the invention is a method for making a polarization splitter or combiner, including: (a) providing a first shaped birefringent optical fiber with a first surface feature having a known orientation with respect to the principal axes of the first fiber; (b) providing a second shaped birefringent optical fiber with a second surface feature having a known orientation with respect to the principal axes of the second fiber; and (c) fusing the first fiber and the second fiber together in an arrangement such that the principal axes of the first fiber are aligned at a known angle with respect to the principal axes of the second fiber.

In a sixth aspect, the invention is a method for making a polarization maintaining coupler, including: (a) providing a first alignment fixture with a first alignment feature; (b) providing a second alignment fixture with a second alignment feature; (c) mounting in the first alignment feature a first surface feature of a first shaped birefringent optical fiber, wherein the first surface feature has a known orientation with respect to the principal axes of the first fiber; (d) mounting in the second alignment feature a second surface feature of a second shaped birefringent optical fiber, wherein the second surface feature has a known orientation with respect to the principal axes of the second fiber; and (e) fusing the first fiber and the second fiber together such that the principal axes of the first fiber are aligned at a known angle with respect to the principal axes of the second fiber.

In a seventh aspect, the invention is a twin-core optical fiber having a first core and a second core, wherein the fiber has at least one of a cross-sectional shape and a surface feature oriented at a known angle with respect to a line between the first core and the second core.

In an eighth aspect, the invention is a birefringent optical fiber including a Bragg grating, wherein the fiber has a non-circular cross-sectional shape.

In a ninth aspect, the invention is an optical fiber including an endface with a nonspherical lens having a lens axis transverse to the longitudinal axis of the fiber, wherein the lens axis has a known orientation with respect to at least one of: (i) an outer surface, and (ii) a surface feature of, the fiber.

In a tenth aspect, the invention is an optical interconnection between two optical fibers with dissimilar cross-sectional shapes, including:

(a) a first fiber having a first optical core, a first effective diameter, and a first endface with an essentially round outer surface;

(b) a second fiber having a second optical core, a second effective diameter, and a second endface with a non-round outer surface; and

(c) an alignment fixture having at least one continuous surface, wherein the first effective diameter and the second effective diameter are not substantially equal, and when the first and second fibers are placed in the alignment fixture with their respective endfaces in abutting relationship in contact with the continuous surface, the first and second optical cores are in optical communication.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of an apparatus for making a poled optical fiber.

FIGS. 2A and 2B are cross-sectional views of two shaped optical fibers that may be used in the apparatus of FIG. 1.

FIG. 3 is a cross-sectional end view of the electrodes of the apparatus of FIG. 1.

FIG. 4 is a perspective view of a grooved cylindrical insulator that may be wrapped with a shaped birefringent optical fiber to form an electric field or voltage sensor.

FIG. 5 is a detail of an area of engagement between a shaped optical fiber and a groove in the cylindrical insulator of FIG. 4.

FIG. 6 is an end view of an apparatus that may be used to write a Bragg grating into a shaped, birefringent optical fiber.

FIG. 7 is an end view of an apparatus that may be used to write a long period grating at an angle into a shaped, birefringent optical fiber.

FIG. 8A is a schematic perspective view of an optical fiber wrapped about an expandable mandrel.

FIG. 8B is a schematic cross-sectional view of a shaped optical fiber wrapped about a mandrel with a corresponding surface feature.

FIG. 9 is an end view of an apparatus that may be used to fuse two shaped birefringent optical fibers together to make a polarization splitter.

FIGS. 10A and 10B are cross-sectional views of two types of shaped, twin core optical fibers.

FIG. 11A is a schematic representation of an optical fiber with a wedge shaped lens.

FIG. 11B is a side view of a shaped optical fiber with a wedge shaped lens.

FIG. 11C is an end view of the wedge shaped lens of the optical fiber of FIG. 1B.

FIG. 12A is an overhead view of an apparatus for aligning the optical fiber of FIG. 111B with a light emitting device.

FIG. 12B is an overhead view of the apparatus of FIG. 12A showing the optical fiber mounted in position to receive the output of the light emitting device.

FIG. 12C is a side view of the apparatus shown in FIG. 12B.

FIG. 12D is a side view of an apparatus for aligning the optical fiber of FIG. 111B with a light emitting device.

FIG. 13A is a schematic cross sectional view of a shaped optical fiber in an alignment apparatus.

FIG. 13B is a schematic cross sectional view of a shaped optical fiber in an alignment apparatus.

FIG. 14 is a schematic cross-sectional view of a diamond shaped fiber and a standard fiber aligned in an alignment apparatus.

Like reference symbols in the various drawings indicate like elements.

### DETAILED DESCRIPTION

Copending U.S. patent application Ser. Nos. 09/515,187 and 09/515,448, incorporated herein by reference, describe specially shaped highly birefringent optical fibers. These fibers have an outer periphery that may be shaped independently of the cross sectional geometry of the highly birefringent waveguiding region. The cross-sectional shape of these optical fibers may be a specific non-circular shape, such as a diamond, a triangle, or the like, or may include an outer surface with one or more features such as, for example, flat sides, bumps, or slots. The transverse axes of the waveguiding region of the fiber preferably have a known orientation with respect to a portion of the outer surface of the fiber or with respect to one or more features on the outer surface of the fiber. The cross-sectional shape of the fiber or features on the fiber surface provide an easily visible, “passive” means of locating the fiber's transverse, orthogonal birefringent axes, which allows the fibers to be easily aligned with other devices without time consuming alignment steps and expensive equipment.

The preform used to make the shaped fibers described in the '187 and '448 applications may be made by a modified chemical vapor deposition (MCVD) process and may include at least one core region having surrounding cladding regions with substantially circular cross sections. However, any preform with a substantially round cross section that is designed to produce an optical fiber with highly birefringent, single mode operation, may be used. Examples include preforms with diametrically opposed stress-applying regions in the cladding, preforms with a core and/or a cladding having a substantially elliptical cross section, and preforms with multiple core regions. Any known process may be used to make these preforms. For example, a rod in tube or outside vapor deposition (OVD) process may be used to form a preform to make an optical fiber with a trade designation PANDA having a substantially circular cross section, a MCVD, an OVD process may be used to form a bow tie preform with a substantially circular cross section, or MCVD may be used to fabricate a preform with a substantially circular cross sectional shape having a core with a substantially elliptical cross sectional shape.

These shaped birefringent fibers are useful in any application where the location of the transverse birefringent axes of the core in a birefringent fiber, or the location of the electro-optic axes in a poled fiber, must be determined with accuracy. Shaped fibers are also useful where the core locations in a dual core or multi-core single mode fiber must be accurately determined.

For example, poled single mode or PM fibers may be used as a transducer in an electro-optic electric field sensor. Prior to use in the sensor, an external electric field is applied along the entire length of a short section of the fiber in a plane normal to the direction of light propagation, which sensitizes the fiber by maximizing its electo-optic coefficient and second order nonlinearity along the direction of the poling field. The sensitized fiber is then helically or spirally coiled on a dielectric cylinder capped by flat electrodes arranged at the two ends of the cylinder. The principal electro-optic axes of the coiled fiber are oriented in a constant direction with respect to an electrical field applied to the electrodes. When the electric field is applied to the electrodes, an electro-optic effect induces a phase difference in the orthogonal components of a light wave traveling down the fiber. In a voltage sensor, for example, this phase difference is directly proportional to the potential difference applied between the electrodes.

These sensors have not been commercially successful in part because there is neither a fast nor an economical way to maintain the alignment of the principal electro-optic axes of a poled single mode or PM fiber as it is sensitized along its entire length. In addition, it is difficult to accurately coil the sensitized fiber along the dielectric cylinder while maintaining the principal axes in a desired direction with respect to the electrical field to be measured. It has been recognized that an elliptically cored PM fiber with a longitudinal flat having a predetermined orientation with respect to the principal axes of the fiber may provide an accurate alignment of the principal axes with respect to the applied field as the fiber is wrapped about the cylinder. Unfortunately, if the flat is placed against the cylinder, the principal electro-optic axes of the fiber are not aligned with respect to the applied field in a direction that produces a suitable electro-optic effect.

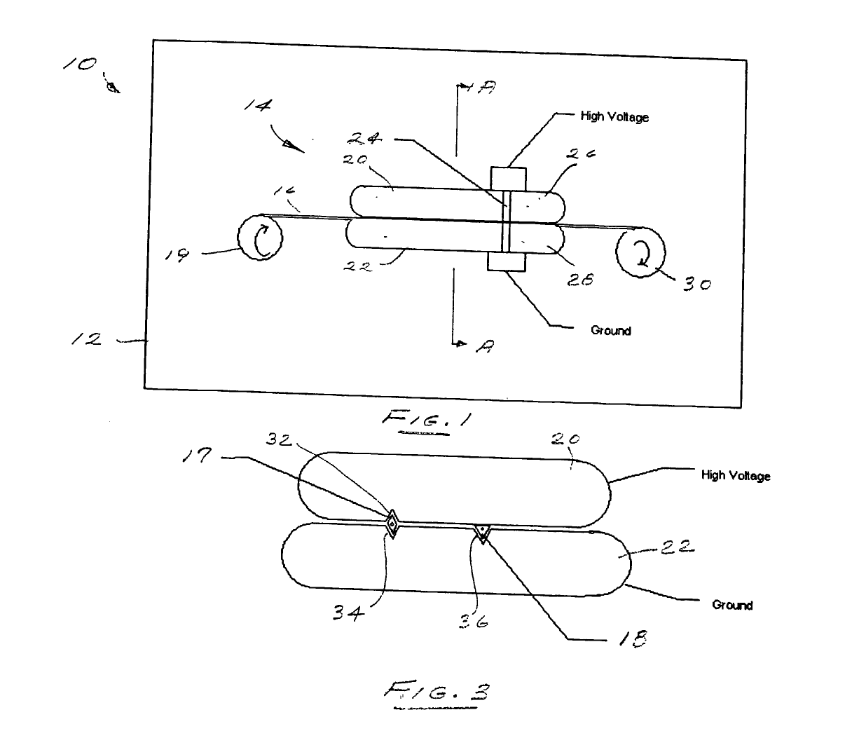

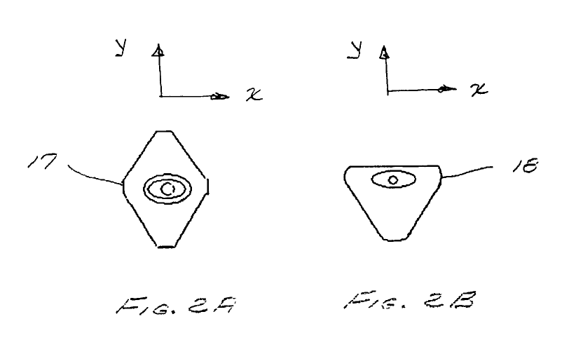

An improved optical fiber poling apparatus 10 is shown in FIG. 1. The apparatus 10, which is enclosed in a gas insulated (N₂ or SF₆, for example) or vacuum chamber 12, includes an optical fiber treatment apparatus 14 for low cost manufacturing of sensitized optical fibers. In this example, a birefringent optical fiber 16, typically a PM fiber, is drawn with a diamond 17 (FIG. 2A) or a triangular 18 (FIG. 2B) cross-sectional shape having a specific orientation with respect to the fast (Y) and slow (X) axes of the optical fiber 16. After the fiber has been coated with a conformal coating (not shown in FIG. 2), it is wound onto a first roll 19 having appropriately shaped grooves to maintain a specific fiber orientation. The shaped fiber 16 is then passed between heated electrodes 20, 22, into a thermal break region 24, between unheated electrodes 26, 28, and onto a grooved take up roll 30.

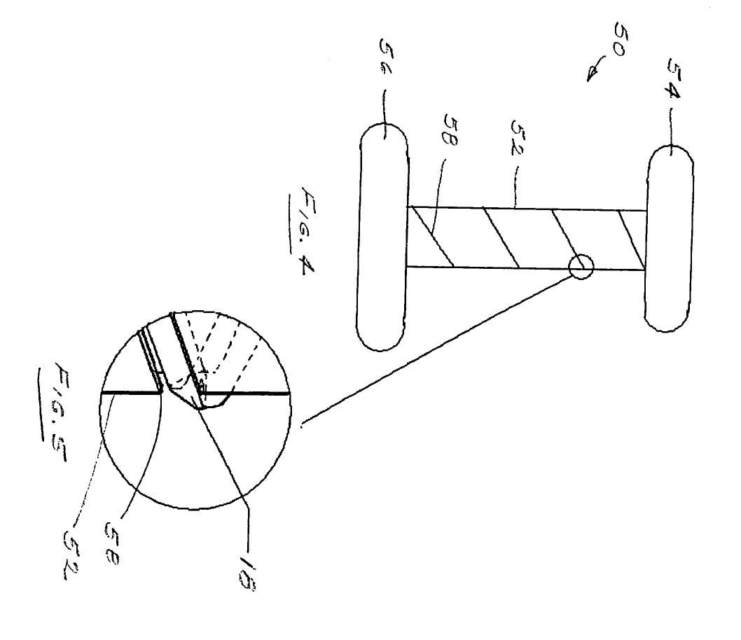

Referring to FIG. 3, the electrodes 20, 22 and 26, 28 include appropriately shaped notches 32, 34, 36 to maintain the orientation of the principal axes of the optical fibers 17, 18 with respect to the electric field of the electrodes as the fibers progress through the sensitization process. Multiple sets of notches may be used to sensitize multiple optical fibers at one time and increase output.

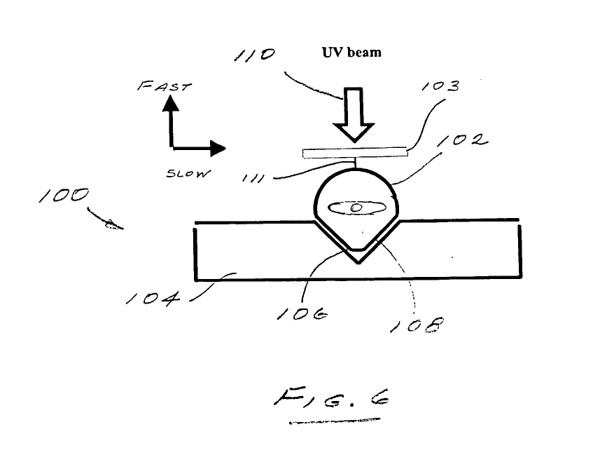

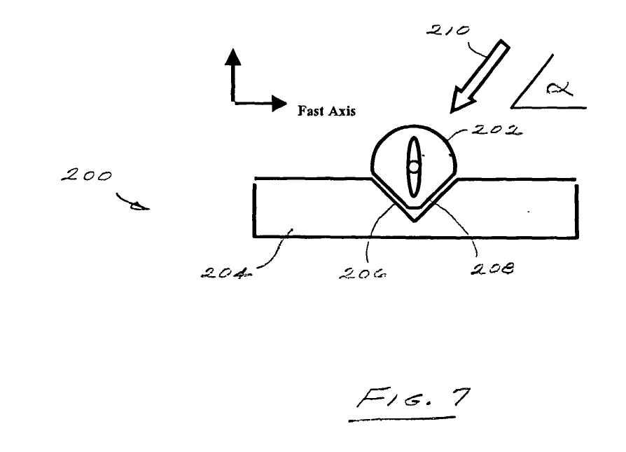

To make a high voltage sensor using the sensitized shaped fiber, the fiber may be unrolled from the take up roll 30 (FIG. 1) and wrapped about a suitably shaped dielectric material. For example, referring to FIG. 4, the sensitized fiber may be wrapped about a cylindrical insulator 52 with electrodes 54, 56 at opposed ends to form a sensor 50. The outer surface of the insulator 52 includes a spiral cut V-groove 58 that substantially matches and receives the vertex angle of the diamond shaped optical fiber 17 (FIG. 2A) or the triangular optical fiber 18 (FIG. 2B). Referring to FIG. 5, as the fiber (in the illustrated embodiment the triangular fiber 18) is wrapped about the insulator 52, the groove 58 orients and maintains the alignment of the poled direction of the optical fiber at a known angle with respect to the electric field to be measured across the electrodes 54, 56.

The shaped optical fibers and the corresponding groove in the sensor insulator provide enhanced alignment accuracy of the principal electro-optic axes of the fiber with the electric field to be measured, which provides a more accurate voltage sensor. In addition, the shaped optical fibers may be made with a wide variety of very highly birefringent core/cladding designs.

Recent work by Fujiwara et al., Electronic Letters 31, 573, Mar. 30, 1995, demonstrated that poling can also be carried out by exposing the fiber to ultraviolet (UV) radiation while the fiber is in a strong electric field. In another embodiment, a heated electrode in the poling apparatus described above may be replaced with an optically transparent electrode of, for example, indium tin oxide on glass or silica, or glass coated with metallized grid or strip patterns. In the poling process described above, UV radiation could then be applied to the fiber through the electrode, and heating may not be required. Alternatively, UV light could be launched down the core of the fiber while the shaped fiber is passed between the unheated poling electrodes.

In another embodiment, application of UV radiation to change the refractive index in an optical fiber core is a method for creating various devices including Bragg gratings or long period gratings. Generally, Bragg gratings are constructed by placing the fiber at the intersection of two UV beams, whose angle of intersection can vary depending upon the type of device. The intersection region at the fiber has different properties which will affect the device created. These properties include an intensity pattern, a UV polarization direction, and the bisector of the UV beam propagation directions. This invention utilizes the mechanical registration of the birefringent fiber to align, at some predetermined angles, the birefringent axis with any or all of the axes described by these properties. The mechanical registration can also serve as an external reference for the orientation of the intensity pattern written into the grating by the UV exposure (in this case the fiber birefringence need not be relevant).

As an example, a chirped fiber Bragg grating (like one used for dispersion compensation) used in reflection will have a net birefringence which is proportional to B·D·λ, where D is the dispersion (in ps/nm), λ is the wavelength, and B is the internal birefringence. The internal birefringence is defined as the birefringence of the fiber due to construction and/or UV exposure and/or any other causes. To reduce this net birefringence, it is possible to splice an additional birefringent fiber to the front of the grating, or to write the grating into a birefringent fiber. In the former case, the splicing must be done to align the additional birefringent fiber with the birefringence of the grating. In the latter case, the UV induced birefringence must be along either the slow or fast axis of the fiber. Both of these processes require knowledge of the principal birefringence axes of the fiber, which can easily be visually identified using the shaped birefringent optical fibers described in the '187 and '448 applications. Once the principal axes are identified, they may be easily aligned with the UV polarization and/or propagation direction.

Another example is the intentional alignment of UV induced birefringence with the axis of a birefringent fiber in order to retain the polarization maintaining properties of the device. Without such alignment, the total birefringence (direction and/or magnitude) can change as a function of length along the fiber, causing the output polarization state to rotate as wavelength changes. This will degrade the performance of any polarization sensitive devices subsequent to this device, as well as the operation of the device itself.

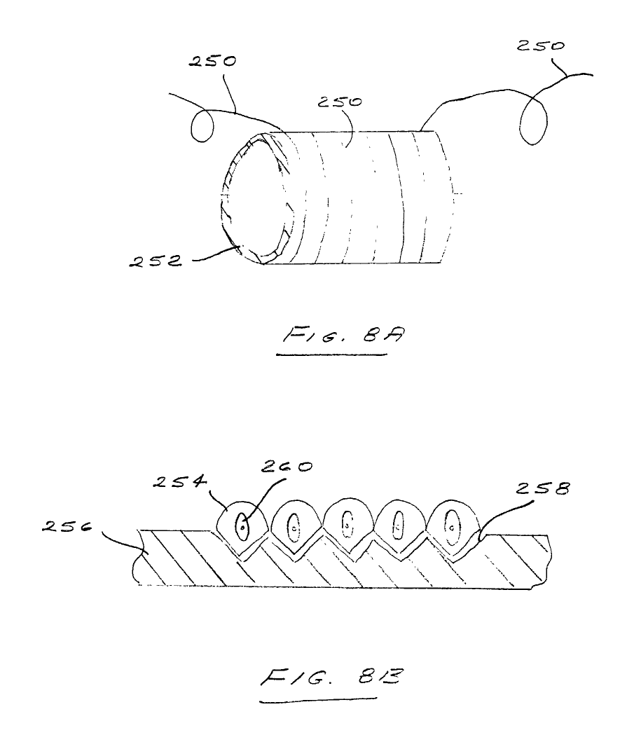

Referring to FIG. 6, an apparatus 100 is shown that may be used to write a Bragg grating into a shaped, birefringent photosensitive optical fiber 102. The apparatus 100 includes a platen or pulley 104 with at least one feature 106 shaped to engage and/or accept a feature 108 (in this example a V-shaped cladding region) on an external surface of the fiber 102, as well as a phase mask 103. The feature 108 is aligned at a known angle with respect to the slow and fast axes of the birefringent fiber 102. The feature 108 allows mechanical registration of the principal axes of the fiber with the bisector 111 of the interfering UV beams 110 used for writing a Bragg grating into the fiber 102. It may be of interest to use other orientations of the fast and slow axis, but in this embodiment either the fast or slow axis will be aligned with the UV beam bisector 111.

Properly configured platens may be used with shaped birefringent optical fibers to make a wide variety of devices with Bragg gratings or long period gratings. For example, rocking filters are fiber devices in which long-period gratings are used to convert light oriented along one principal axis of a birefringent fiber to light oriented along the other principal axis. Polarization conversion occurs when the wavevector corresponding to the long period grating is equal to the difference between the wavevectors of light traveling on the principal axes (the “fast” and “slow” or relatively lower and higher effective indices). Equivalently, the spatial period of the grating is equal to the beat length of the birefringent fiber. The long period grating can be generated by various means, including by imposing an external periodic stress on the fiber, or more conventionally, by writing a photoinduced periodic refractive index pattern in the fiber using a series of localized UV exposures spaced along the fiber. Applications of rocking filters include wavelength filtering and control of differential polarization delay for polarization mode dispersion compensators. In this last application, rocking filters transfer signals between the fast and slow axes of propagation in sections of PM fiber in a controlled way, thus adjusting the relative time delay between the two signals.

In order for photorefractive rocking filters to achieve efficient conversion between polarization states, the grating must be written with the UV light incident at 45 degrees from the birefringent axes of the fiber. Since rocking filters can be several centimeters in length, maintaining accurate orientation of the fiber with respect to the light over the entire grating length can be difficult. With normal birefringent fiber, this is difficult because the exterior of the fiber is round, and there is no feature for observing the orientation of the fiber, or for holding it in the proper orientation. Conventional approaches to the problem require observing the cleaved end of the fiber to locate the internal fiber structures that induce the birefringence, and then attempting to orient these structures in the writing fixture, and maintaining the orientation during writing. This approach is tedious, time consuming, and can result in poor alignment accuracy that degrades the performance of the rocking filter. Therefore, improved means of initially orienting the fiber, and maintaining the orientation is needed.

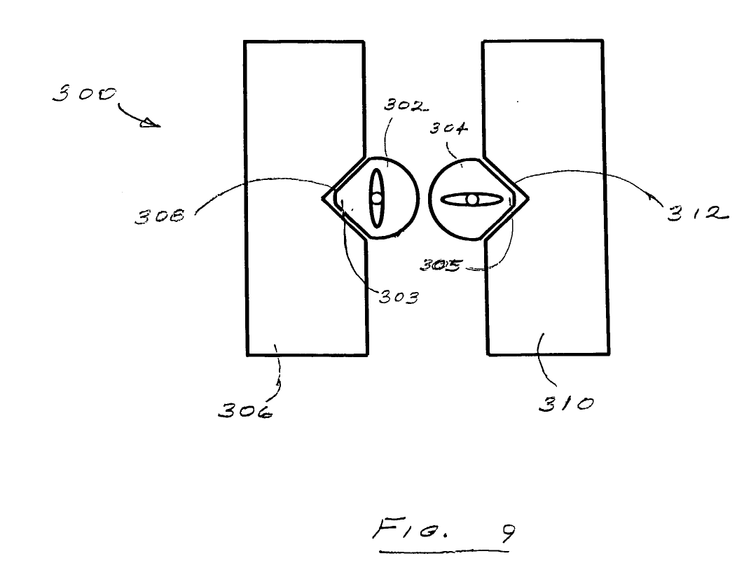

Referring to FIG. 7, an apparatus 200 is shown that may be used to make a rocking filter from a shaped, birefringent photosensitive optical fiber 202. The apparatus 200 includes a platen 204 with at least one feature 206 shaped to engage and/or accept a feature 208 (in this example a V-shaped cladding region) on an external surface of the fiber 202. The feature 208 is aligned at a known angle with respect to the slow and fast axes of the birefringent fiber 202. The feature 208 allows mechanical registration of the principal axes of the fiber with respect to the intensity distribution resulting from a one or more UV beams 210 used for writing a long period grating (or a Bragg grating). In FIG. 7, the angle α is the angle between the UV beam propagation direction (when writing a long period grating), or the bisector of the UV beams (when writing a Bragg grating), and the birefringent axis of the fiber 202. The resulting optical device may be used as a rocking filter.

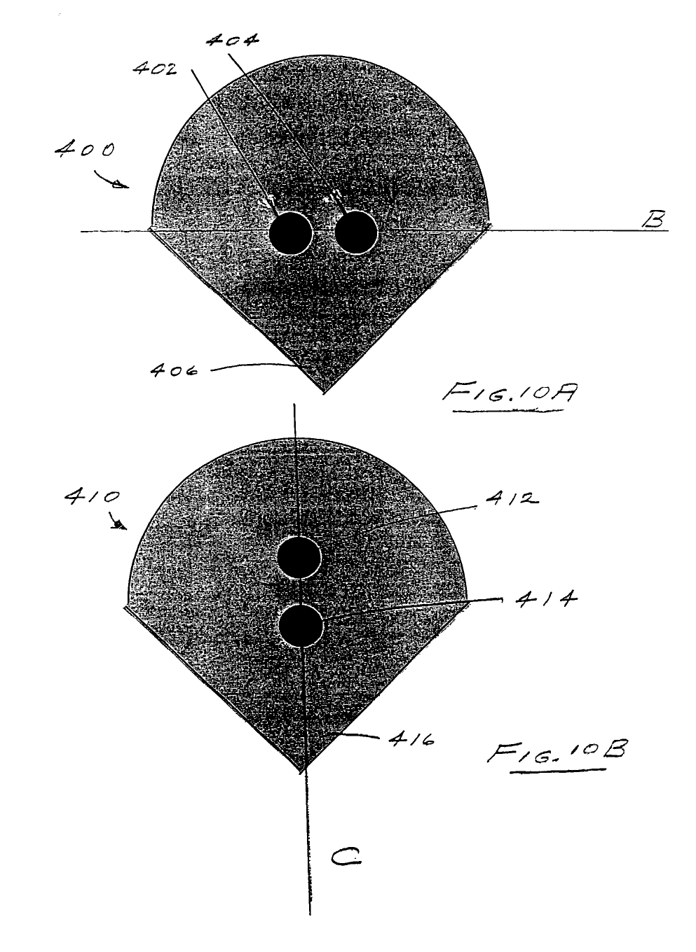

Shaped optical fibers may be used to advantage in aspects of packaging optical fiber Bragg gratings. Gratings are typically written in a short length of an optical fiber and are wavelength tuned by linearly stretching the fiber by pulling on its ends, or by otherwise straining the fiber. For example, as shown in FIG. 8A, to reduce package size and stabilize such a device, an optical fiber 250 containing the grating may be placed under linear tension by wrapping the fiber about an expandable cylindrical mandrel, such as a piezoelectric actuator 252. The mandrel 252 may then be expanded radially to stretch the grating in the fiber 250. For example, if the grating were long (more than several centimeters), a conventional stretching approach would not allow for a device that would fit in a standard package and may result in a device that is susceptible to vibrations. Such a wavelength tunable fiber Bragg grating device might be used, for example, as the wavelength-selective portion of a spectrum analyzer. A shaped fiber grating used in a spectrum analyzer could also be a linearly or non-linearly chirped grating, wherein different wavelengths are reflected at different distances along the grating.

When a grating is written, a small birefringence is induced, whose orientation is determined by the write direction. Having such a grating written in a shaped fiber allows this induced birefringence to be registered to an external feature of the fiber throughout its entire length. Furthermore, in the case of a PM fiber, the induced birefringence will also be registered to the internal birefringence axes of the fiber. Referring to FIG. 8B, when such a shaped fiber 254 is placed under tension by, for example, wrapping the fiber around a mandrel 256 that has surface features 258 to match, engage and/or accept the shape of a feature or a shape of an outer surface of the fiber, all axes 260 of importance are registered to the axes of the mandrel. Such a device will have a well defined birefringence that may be more easily compensated for, if necessary.

In another embodiment, a shaped fiber wrapped around an appropriately configured expandable mandrel and encased in a potting material, such as a UV or chemically curable, thermoset or thermoplastic material, such as, for example, a curable epoxy adhesive, can be used for polarization rotation. If the fiber is standard single mode fiber, such a procedure results in a slight birefringence due to bending of the fiber. Aligning the angle of the induced or permanent polarization axis (for PM fiber) of the fiber precisely with respect to the expandable mandrel can greatly improve the ability to control the polarization since the stress will be applied in a uniform direction along the whole length of fiber with respect to any internal birefringence. Encasing the fiber in epoxy actually allows for a magnification of the effects of the expandable mandrel since a large effective squeezing force is experienced by the fiber as the expanding actuator presses it against the epoxy potting. This arrangement can be used to reduce the amount of expansion necessary to achieve polarization rotation (this can also be applied to the case where a Bragg grating is stretched since the squeezing affords an index change, which may be equivalent in many cases to a length change in functionality; for example for tunable Bragg grating applications). In this case (epoxy encapsulation), birefringent axes are most desirably registered to the mandrel since any twist of the fiber combined with the large stress modulation over the length of the fiber (typically a meter or more) may result in unwanted polarization mode coupling.

In another Bragg grating application, shaped optical fibers may be used to identify the alignment direction of a blazed grating. Typically, fiber Bragg gratings are made so that the grating fringes are as perpendicular as possible to the fiber's longitudinal axis, but some applications, such as side-tapping and reflection-reduction, require the grating fringes to be written into the fiber with an angle to the longitudinal fiber axis. By tilting, or “blazing”, the grating, the coupling between the core mode and radiation modes is enhanced, so these gratings are also referred to as radiation-mode couplers.

A tilted grating can be used as a light tap, where a portion of the light in the fiber core is routed out of the fiber for subsequent analysis. In strongly tilted gratings, i.e. gratings with a large angle with respect to the direction of light travel down the length of the optical fiber, the light coupled into radiation modes by the tilted grating is strongly polarized, allowing researchers to make in-line polarimeters that may be used in polarization mode dispersion (PMD) compensator applications and polarization interleavers.

Polarimeters have been made by fabricating a set of four tilted gratings oriented at various angles with respect to one another into the fiber, as shown in FIG. 1 of Westbrook, Strasser, and Erdogan, Compact in-line Polarimeter Using Fiber Gratings,” Optical Fiber Communication Conference 2000 (Optical Society of America, Washington, D.C.), PD22. During fabrication of such a device, a shaped photosensitive fiber would facilitate the manufacture of these tilted gratings, since one could detect the orientation of the various gratings written internal to the fiber by the external fiber shape. The polarized light is emitted at various angles and positions from the fiber. To mount detectors to each of the four tilted gratings, one typically must launch light into the fiber and detect where the light is emitted to mount the detectors. By fabricating the tilted gratings into a shaped fiber, one can register and mount detectors for the polarimeter based on the fiber external shape without the need to launch light into the fiber, thereby eliminating complicated steps in a manufacturing process and reducing costs.

The tilted grating can also be chirped so that different wavelengths of light are emitted at different locations along the fiber length. A detector array, such as a charge coupled device (CCD), can be mounted onto the side of the fiber from where the light is emitted and the wavelengths of light traveling down the fiber can be detected and monitored. A device of this nature would be useful in dense wavelength division multiplexing (DWDM) telecommunications applications, for example to monitor the strength and wavelength of communications channels propagating down the fiber. As with the polarimeter, one must launch light into the fiber and detect where the light is emitted to mount the detectors. Shaped fibers can eliminate these complicated steps in a manufacturing process and reduce the device costs.

In yet another embodiment, optical fiber Bragg gratings may also be written in a polarization-maintaining (PM) fiber for use in polarization optical delay lines. Polarization delay lines are an integral component of polarization mode dispersion (PMD) compensators. An optical signal in a network system accumulates PMD as a result of traveling through the optical fiber and optical components. It will acquire a differential delay between the two orthogonal states of polarization supported by the fiber. This delay results in signal dispersion, and if severe, an inability to determine the information content of the signal.

The delay between the orthogonal polarization states may be reduced with two chirped gratings written in a PM fiber. Each of the two orthogonal polarization states is sent down one of the fibers and is reflected from the chirped grating. By tuning one of the gratings with respect to the other, the reflection point in the grating changes, and the light travels a shorter path in one of the legs. By correctly delaying the polarization that was leading in the optical signal, the signal can be recombined after reflecting from the gratings, thus reducing or eliminating the differential delay.

Using PM fiber in the polarization delay line has an advantage over standard single-mode (SM) fiber. If the signal is launched correctly into the PM fiber, it will maintain its state of polarization upon reflection from the chirped grating, and thus can be recombined with the orthogonal polarization reflected in the other grating using a polarization beamsplitter. A polarization beamsplitter, also called a polarization splitter or combiner, allows one beam to be split into two orthogonal polarization components or, when operated in reverse, allows two oncoming orthogonal polarization component beams to be combined into one beam. Having a shaped outer surface or feature on the fiber aids in writing the grating in the fiber, as a more uniform grating provides better performance.

PM fiber can also be used in another component of a PMD compensator, a polarization transformer, which transforms and aligns the two orthogonal states of polarization supported in the fiber to the polarization delay line. Multiple polarization rotators may be combined to create this polarization transformation. In one embodiment, each rotator is made by winding many loops of PM fiber onto a piezo-electric actuated expandable cylinder (See, for example, FIG. 8A). By subsequently expanding the cylinder radially, the stretch is transferred to the PM fiber, rotating the polarization state in the fiber. But if the fiber is twisted when it is wound onto the cylinder, the change in polarization with stretching is affected, and can be reduced. To avoid this, a PM fiber with a consistent, shaped outer feature will eliminate twists in the fiber, and improve performance of the rotators.

The shaped fibers may be used in a wide variety of optical fiber devices in which multiple birefringent fibers and/or multiple Bragg gratings in the fibers are oriented with respect to one another. For example, fused fiber polarization splitters (and equivalently, polarization combiners) are key components of many important fiber optic systems including pump combiners for Er-doped and Raman fiber amplifiers, polarization mode dispersion compensation systems, and a variety of fiber sensors. These components may be fabricated by fusing two birefringent (typically polarization-maintaining (PM)) fibers together with two surfaces in contact, preferably in a side-by-side arrangement. In performing the fusion, it is necessary to control the orientation of the birefringent axes of the PM fibers while the fusing takes place, to obtain good polarization coupling and extinction. With normal PM fiber, this is difficult because the exterior of the fiber is round, and there is no feature for observing the orientation of the fiber, or for holding it in the proper orientation. Conventional approaches to the problem require observing the cleaved end of the fiber to locate the internal fiber structures that induce the birefringence, and then visually orienting these structures in the fusion fixture, which is meant to maintain the orientation during fusion. This approach is tedious, time consuming, and can result in poor alignment accuracy that degrades the performance of the coupler.

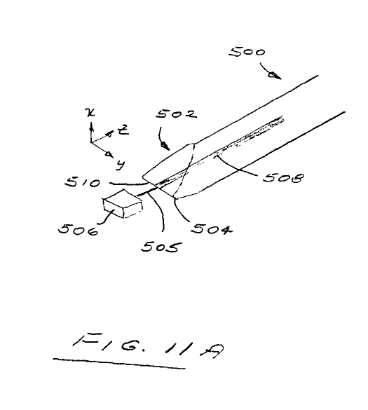

Referring to FIG. 9, an apparatus 300 is shown that may be used to fuse two shaped birefringent optical fibers 302 and 304 together in a side-by-side arrangement to make a polarization splitter. Each of the fibers 302 and 304 include a surface feature 303, 305 with a known orientation with respect to the principal axes of the fiber. The apparatus 300 includes a first alignment fixture 306 with an appropriately shaped feature 308 designed to engage and/or accept a surface feature in the fiber 302. A second alignment fixture 310 includes a second shaped feature 312 designed to engage and/or accept a surface feature of the fiber 304. As shown in FIG. 9, the fast axis of the fiber 302 is to be fused to the slow axis of the fiber 304 to form the polarization splitter, although other alignments are possible.

A process very similar to that described above and shown in FIG. 9 can be used to produce a polarization-maintaining (PM) coupler. In a PM coupler, (at least) two PM fibers are fused together side-by-side at a location along their lengths, with the fast axis of one fiber aligned with the fast axis of the other fiber. (The line joining the two cores in the fused region will lie along either the fast axes or the slow axes of both fibers.) This permits light launched with its linear polarization vector aligned parallel to, e.g., the fast axis of one input fiber to exit the coupler with its polarization vector aligned parallel to the fast axis of one or both of the output coupler fibers. This is in contrast to the polarization combiner/splitter, where the fast axis of one fiber is aligned with the slow axis of the other fiber in the fused region. The use of shaped highly birefringent fiber would simplify and improve the quality of the alignment step in the preparation of PM couplers, in a manner similar to that shown for polarization combiners in FIG. 9.

A polarization-maintaining coupler as described in the paragraph above can be used to fabricate another optical device known as a depolarizer, as disclosed in U.S. Pat. No. 5,218,652 and the related technical article by Lutz, IEEE Photonics Technology Letters, Vol. 4, No. 4, April 1993, pp. 463-465. One purpose of this device is to take a (preferably constant intensity) input of any random state of polarization and convert it to an output that is completely unpolarized. One embodiment of such a depolarizer device is made from a PM coupler having two PM input fiber ends (e.g., A and B), two PM output fiber ends, and a coupling ratio such that at least ⅔ of the light entering input A will exit a particular output, e.g., D. Output D is then optically connected to input B to form a recursive loop. The degree of depolarization can then be tuned by adjusting the angles between the polarization axes of fibers D and B in the loop, as indicated in FIG. 1 of the above patent and FIGS. 1-4 of the technical article. Using shaped birefringent fibers to make the PM coupler would make it significantly easier to locate the polarization axes in fibers D and B, and to hold the fibers and rotationally adjust the angle between the polarization axes of the two fibers at the optical connection point. The fiber ends could, for example, be placed facing each other with their cores aligned, each in a V-groove holder similar to 306 in FIG. 9, where the V-groove holders are mounted in such a way that they may be rotated around the axis of the fiber cores. Such rotation of one of the V-groove holders would adjust the angle between the polarization axes of D and B without changing the intensity of the light transmitted from D to B.

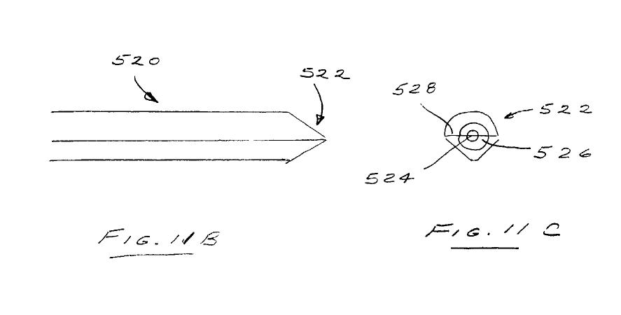

In another aspect, in a twin core fiber it is difficult to discern the proper orientation of the fiber. In every operation using twin core fiber, an initial orientation step is required, which greatly increases production time and costs. This orientation step makes it difficult and time consuming to write a Bragg grating into one or both cores, to selectively irradiate one core with light, or to splice the twin core fiber to a standard single mode fiber. Referring to FIG. 10A, a shaped optical fiber 400 is shown that includes twin cores 402, 404, and an alignment feature 406 oriented normal to a line B drawn between the cores. Referring to FIG. 10B, another shaped optical fiber 410 is shown with twin cores 412 and 414, and an alignment feature 416 oriented parallel to a line C drawn between the cores. Each design allows the assembler to assess the position of the feature, which allows rapid identification of the core orientation and position.

Rapid core orientation would greatly reduce the costs of many devices made using twin core fibers. For example, a coupler may be made in a twin core fiber by heating a section, typically with a laser, and then simultaneously writing a linear or non-linear chirped Bragg grating in both cores. This Michelson interferometer device, which does not require a circulator, provides low cost signal dispersion compensation and saves about 1.5 dB of insertion loss. A similar device could be used as a dispersion clean-up device at a receiver or as a PMD compensation variable delay line. In addition, Mach-Zehnder interferometer devices could be manufactured by making two couplers along a length of fiber, then trimming using UV or localized heat to adjust one of the interferometer legs, or by simultaneously writing a Bragg grating into both cores before the couplers are made, and then making the couplers using localized heat treatment. Further, frustrated coupler devices could be used by, for example, UV irradiating one fiber and writing a Bragg grating into another to make an add-drop coupler. Optical switches may be made by polishing down into the fiber to access the evanescent fields of one or both fiber cores in the twin core fiber. A material such as, for example, LiNbO₃, may be applied against the region that accesses the modes in the cores and controls the coupling of energy from one core to another. Alternatively, a localized heat source along a coupler in the twin core fiber could be used to thermally control coupling from one core to another.

Shaped fibers, both birefringent and non-birefringent, are also useful in any application where a location of an external feature of the fiber must be determined with accuracy. As noted above, both single mode (non-birefringent) and PM/PZ fibers may include lensed tips to couple with a light emitting device. The lenses may or may not be rotationally symmetrical.

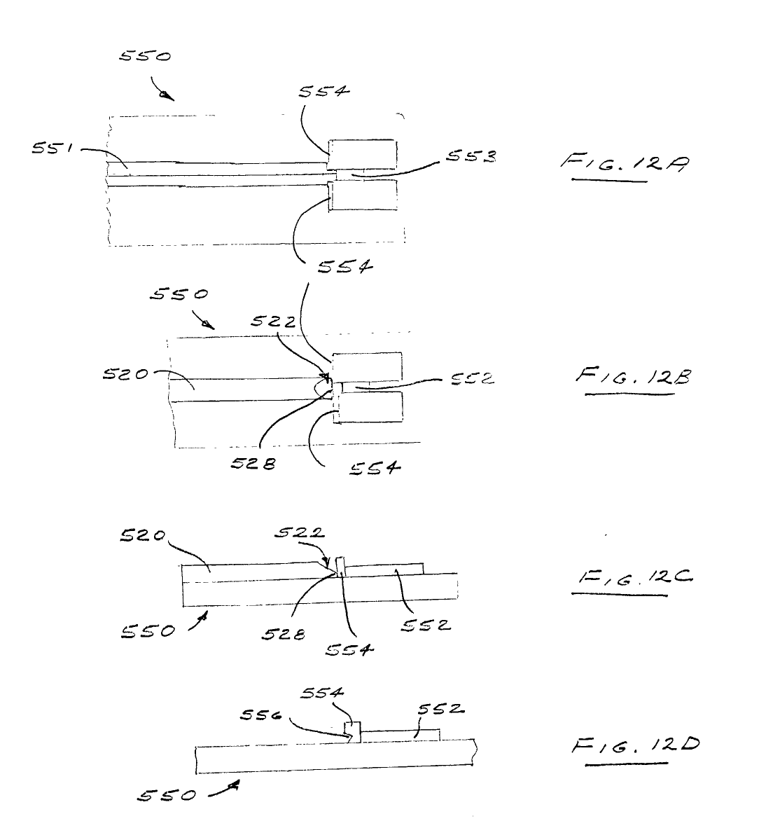

For example, referring to FIG. 11A, a single mode fiber 500 is shown that includes a non-rotationally symmetrical wedge-shaped lens tip 502. The lens tip 502 includes a cylindrical end face 504. Light 505 emitted by a semiconductor device 506 may be coupled into a core region 508 of the fiber 500 via the cylindrical end face 504. The device 506 typically emits a highly elliptical beam, so the efficiency of this coupling depends on the accuracy of the alignment between the rotational angle of the axes of the light emitted from the device 506 and a linear leading edge 510 formed by the intersecting faces of the wedge lens 502. The leading edge 510 of the lens 502 is typically oriented transverse to a longitudinal axis of the optical fiber 500.

If the wedge-shaped lens tip is formed on a PM or a PZ fiber, then the efficiency of the coupling depends on two alignment steps. First, the leading edge 510 of the wedge-shaped lens must be rotationally aligned with the internal birefringent axes of the fiber, and then the surfaces of the light emitting device must be rotationally aligned with the line formed by the intersecting faces of the lens, referred to herein as the lens axis. Even if the lens on the PM or PZ fiber is rotationally symmetrical (for example, a conical lens), the internal birefringent axes of the fiber must still be aligned with the axes of the light emitted from the device. The elliptical output beam may also be polarized along the axes of the beam ellipse.

Referring to FIG. 11B, a lensed optical fiber 520, which may or may not be birefringent, is shown that has a non-circular, substantially V-shaped cross section and includes a wedge-shaped lens 522. As shown in FIG. 11C, a linear leading edge 528 formed by the intersecting faces of the wedge lens 522 intersects the centers of a core region 524 and a cladding region 526 of the fiber 520.

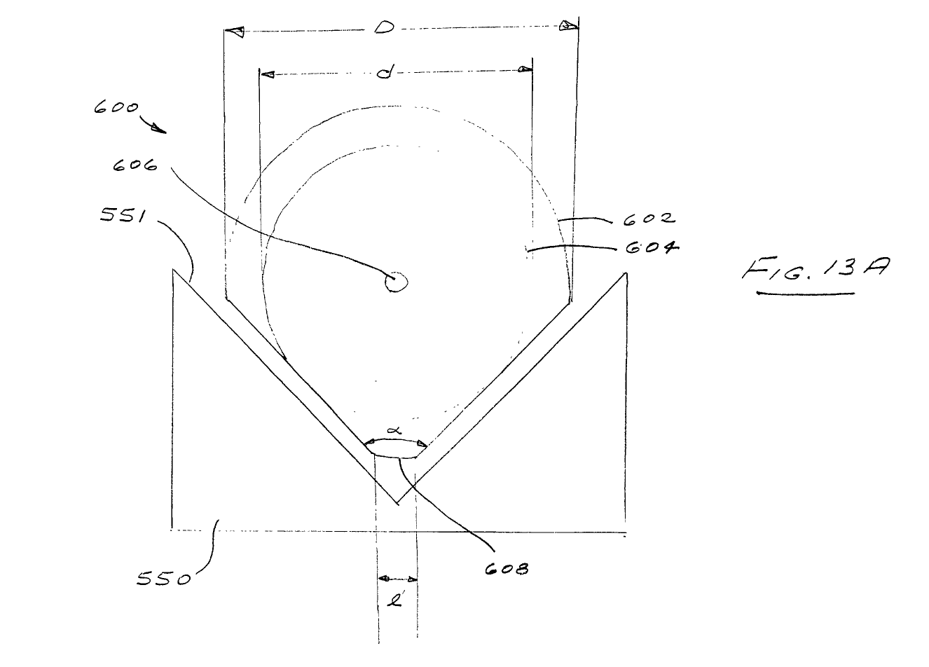

Referring to FIGS. 12A-C, an alignment device 550 may be configured with a longitudinal V-shaped groove 551 designed to accept the V-shaped cross section of the fiber 520 of FIG. 11B. A light emitting device 552 may be positioned in a receptacle 553 behind a raised stop 554 on the alignment device 550. The receptacle 553 is colinear with the V-shaped groove 551. The light emitting device 552 is placed in the receptacle 553 such that the rotational alignment of the axes of its emitted light are known. As shown in FIG. 12B, the fiber 520 may be engaged with the V-shaped groove 551 and moved along the groove 551 until the leading edge 528 of the wedge lens 522 abuts the raised stop 554. If the wedge lens 522 and the leading edge 528 are aligned with respect to the internal birefringent axes of the fiber 520, then no further rotational alignment procedure is necessary to align the fiber 520 and the light emitting device 552. Referring to FIG. 12D, the stop 554 may optionally include a wedge-shaped notch 556 to securely retain the fiber 520 in the receptacle 553.

To align a standard single mode fiber (circular cross-sectional shape, non-birefringent) with a light emitting device, a short piece of the shaped fiber 520, which is shown in FIG. 1B-C, could be connected or spliced to an end of the single mode fiber. The V-shaped fiber section could then be inserted into the alignment device 550 to align the single mode fiber with the light emitting device. A similar connection/splicing technique could be used for PM/PZ fiber, but the splicing step would require a rotational alignment to ensure registration between the internal birefringent axes of the PM/PZ fiber and the shaped fiber. Similarly, short sections of standard single mode or PM/PZ could be connected/spliced to shaped fibers to take advantage of special or standard lens designs on the standard fibers, particularly if the lens design is difficult and/or expensive to fabricate on the shaped fiber. Alternatively, a long length of standard fiber may be connected/spliced to a shaped optical fiber for insertion into an alignment device, then the shaped optical fiber could be connected/spliced to a short length of standard fiber with a particular lens design.

The alignment device 550, which includes the longitudinal V-shaped groove 551, may be used as shown in FIGS. 12A-D to align optical fibers to light emitting devices, or, to align fibers to one another. The groove 551 limits the side-to-side movement of the fiber during the alignment procedure, and provides a rotational alignment function as well. In addition, the alignment groove may be used, along with the shape and size of the shaped fibers, to facilitate alignment of fibers with different diameters and core/cladding regions. For example, a standard 125 micron fiber with a unique core design or shape, such as a Panda fiber, could be placed in abutting relationship and aligned with a specially shaped optical fiber in the V-groove 551 of the alignment device 550 (See FIG. 12).

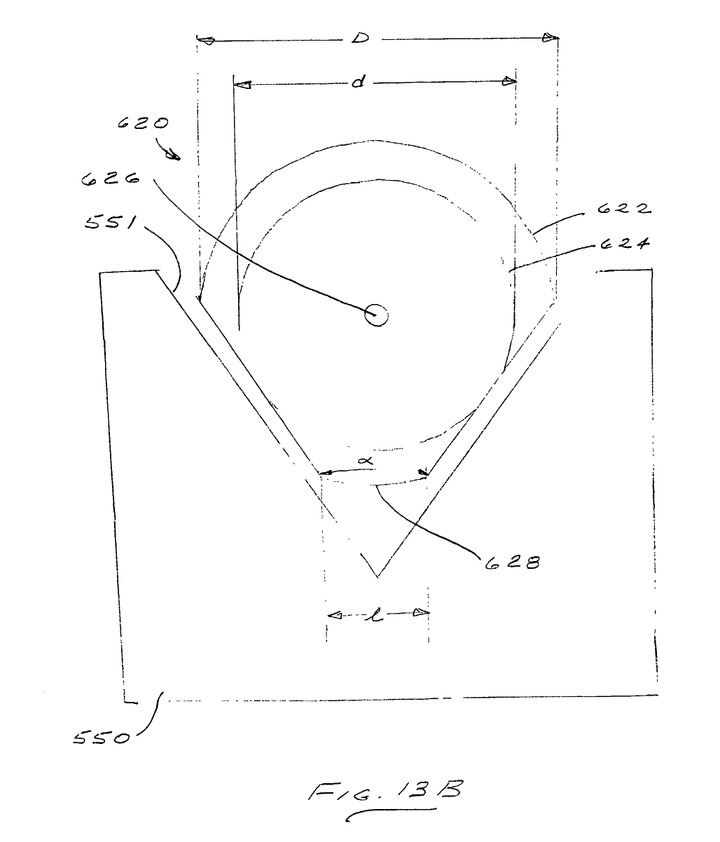

Referring to FIG. 13A, a specially shaped optical fiber 600 has an outer region 602 with an effective diameter D of 160 microns and a concentric core region 606, and includes a vertex angle a of 90° designed to engage a 90° V-groove 551 in the alignment device 550. The fiber 600 may optionally include a conformal coating (not shown in FIG. 13A). The wedge shape of this fiber may be considered to be made by drawing two symmetric chords at an angle of 90° to each other on a circle of diameter 160 microns, representing the fiber endface, then removing the material located outside the chords. The distance from the center of core region 606 to the midpoint of one of the flat faces, along with the angle of the V-groove and matching fiber wedge (which in this example is 90°) will determine the height of core region 606 above the bottom of the V-groove. To make an effective optical interconnection with a standard 125 micron diameter round fiber represented by outline 604 with diameter d), the cores of both the shaped fiber and the standard fiber must be at the same height above the centerline of the V-groove. The standard fiber touches the sides of the V-groove only at two points, and the distance from the points of contact to the center of the core of the standard fiber is equal to the radius of the fiber, d/2. For the 160 micron diameter shaped fiber to have a center-to-flat-face distance equal to d/2=62.5 microns in this example, the fiber must be shaped such that the chords of removed material leave behind a small rounded “lip” between them at their nearest points, this lip having a chord length 1 of 18 microns. When the shaped fiber is shaped in this manner, its core region 606 will optically align with a 125 micron diameter round fiber when both fibers are laid in the 90° V-groove 551 with their endfaces abutting. This height matching greatly eases the alignment procedure between the shaped fiber 600 and a standard 125 micron fiber. In another example shown in FIG. 13B, a shaped fiber 620 with an included angle of 70° provides a lower lip length 628 having a length 1 of 46 microns, while maintaining the outer region 622 with a diameter D of 160 microns. A core region 626 of the fiber 620 is centered in a circle 624 with a diameter of 125 microns that touches the points where the shaped fiber contacts the V-groove, to provide compatibility with standard 125 micron fibers. In certain applications the extended lip length of the 70° fiber provides enhanced stability in the groove 551. The core region of the shaped fiber need not be at the center of the arc defining the effective diameter D, as long as appropriate adjustments are made to the fiber shape design to allow for desired interconnection with other fibers.

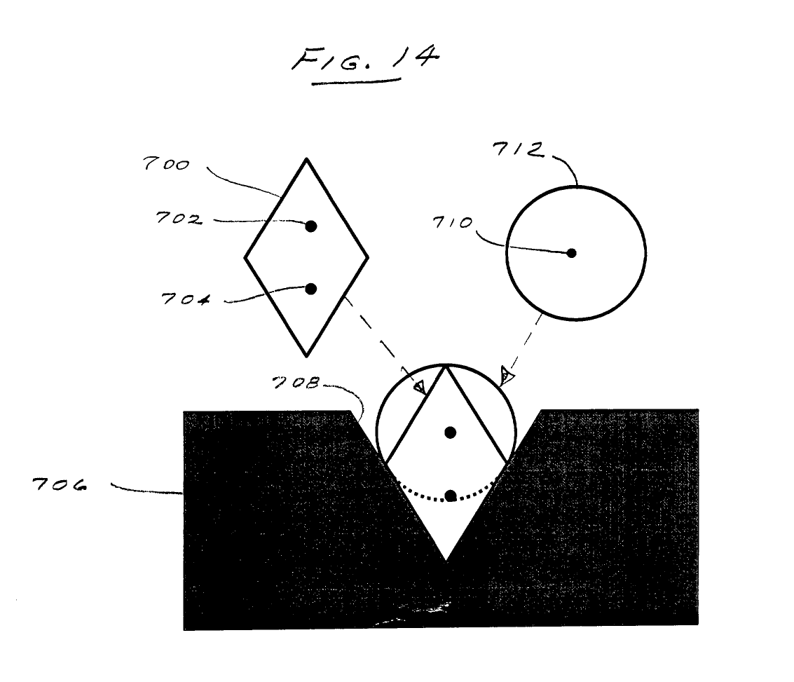

In another embodiment shown in FIG. 14, an optical fiber 700 with a diamond cross-sectional shape includes a first core region 702 and a second core region 704. Using an alignment device 706 with an appropriately shaped and sized V-groove 708, the first core region 702 of the diamond-shaped fiber 700 may be readily aligned in abutting relationship with a core 710 of a standard fiber 712 having a circular cross section.

A number of embodiments of the invention have been described. Nevertheless, it will be understood that various modifications may be made without departing from the spirit and scope of the invention. Accordingly, other embodiments are within the scope of the following claims.

What is claimed is:

1. A method for sensitizing an optical fiber, comprising: (a) providing a section of a shaped optical fiber having a waveguiding region with a known internal geometry, wherein the waveguiding region is oriented at a known angle with respect to one of: (i) a portion of an outer surface of the fiber, and (ii) one or more features on the outer surface of the fiber; and (b) passing the fiber between a first electrode and a second electrode such that an electric field is applied to the waveguiding region, wherein at least one of the first and second electrodes have a feature that engages at least one of the portion of the outer surface of the fiber and the feature of the fiber to maintain the orientation of the waveguiding region of the optical fiber with respect to the applied electric field.

2. The method of claim 1, wherein the fiber is birefringent and the internal geometry of the waveguiding includes transverse axes, and wherein, during step (b), the transverse axes are aligned in a known relationship with the applied electric field.

3. The method of claim 1, wherein the fiber has one of a diamond or a triangular cross sectional shape, and at least one of the electrodes has a grooved feature

4. The method of claim 1, wherein the fiber is unrolled from a grooved roller prior to step (b).

5. The method of claim 1, wherein the first and the second electrodes comprise a hot region, a cold region, and a thermal break region.

6. A method for making an electric field sensor, comprising: (a) providing a shaped optical fiber having a waveguiding region with transverse axes, wherein the axes are oriented at a known angle with respect to one of: (i) a portion of an outer surface of the fiber, and (ii) one or more features on the outer surface of the fiber; (b) poling the fiber; and (c) wrapping the fiber about a cylindrical insulator, wherein an outer surface of the insulator comprises a feature that engages at least one of the portion of the outer surface of the fiber and the feature of the fiber to maintain the orientation of the waveguiding region of the optical fiber with respect to an applied electric field, and (d), applying an electric field to the optical fiber to produce electro-optic axes exhibiting a phase difference in light transmitted through the optical fiber, wherein the phase difference has a known orientation with respect to the transverse axes of the fiber.

7. The method of claim 6, wherein the fiber has one of a diamond or a triangular cross sectional shape, and the insulator has a grooved feature.

8. An electrical voltage sensor comprising a birefringent optical fiber, wherein the fiber has a non-circular cross sectional shape.

9. The sensor of claim 8, wherein the fiber has one of a diamond and a triangular cross sectional shape.

10. The sensor of claim 8, wherein the electric field sensor is a voltage sensor.

11. A method for making an optical fiber Bragg grating, comprising providing an orientation device having a surface feature; inserting into the surface feature of the orientation device a shaped optical fiber having a waveguiding region with transverse axes, wherein the axes are oriented at a known angle with respect to one of: (i) a portion of an outer surface of the fiber, and (ii) one or more features on the outer surface of the fiber; and writing a Bragg grating in the waveguiding region at a known angle with respect to the transverse axes of the waveguiding region.

12. The method of claim 11, wherein the grating is chirped.

13. The method of claim 11, wherein the grating is blazed.

14. The method of claim 13, wherein the grating is blazed at a known angle with respect to one of: (i) a portion of an outer surface of the fiber, and (ii) one or more features on the outer surface of the fiber.

15. The method of claim 11, wherein the orientation device is a mandrel.

16. A method for altering the birefringence of an optical fiber, comprising: (a) providing a shaped optical fiber having a waveguiding region with transverse axes, wherein the axes are oriented at a known angle with respect to one of: (i) a portion of an outer surface of the fiber, and (ii) one or more features on the outer surface of the fiber, (b) straining the optical fiber in a device having a surface with a feature that engages at least one of the portion of the outer surface of the fiber and the feature of the fiber to maintain the orientation of the waveguiding region of the fiber with respect to the device.

17. The method of claim 16, wherein the device is a mandrel with a circular cross section, and wherein the fiber is wrapped under tension about the mandrel, and (c) radially expanding the surface of the mandrel.

18. The method of claim 16, wherein the fiber further comprises a Bragg grating in the waveguiding region.

19. The method of claim 17, wherein the fiber is potted with a potting material prior to step (c).

20. The method of claim 17, wherein the mandrel is piezoelectric.

21. The method of claim 19, wherein the potting material is a curable epoxy adhesive.

22. A method for making a polarization splitter or combiner, comprising: (a) providing a first shaped birefringent optical fiber with a first surface feature having a known orientation with respect to the principal axes of the first fiber; (b) providing a second shaped birefringent optical fiber with a second surface feature having a known orientation with respect to the principal axes of the second fiber; and (c) fusing the first fiber and the second fiber together in an arrangement such that the principal axes of the first fiber are aligned at a known angle with respect to the principal axes of the second fiber.

23. A method for making a polarization maintaining coupler, comprising: (a) providing a first alignment fixture with a first alignment feature; (b) providing a second alignment fixture with a second alignment feature; (c) mounting in the first alignment feature a first surface feature of a first shaped birefringent optical fiber, wherein the first surface feature has a known orientation with respect to the principal axes of the first fiber; (d) mounting in the second alignment feature a second surface feature of a second shaped birefringent optical fiber, wherein the second surface feature has a known orientation with respect to the principal axes of the second fiber; and (e) fusing the first fiber and the second fiber together such that the principal axes of the first fiber are aligned at a known angle with respect to the principal axes of the second fiber.

24. A twin-core optical fiber having a first core and a second core, wherein the fiber has at least one of a cross-sectional shape and a surface feature oriented at a known angle with respect to a line between the first core and the second core.

25. A birefringent optical fiber comprising a Bragg grating, wherein the fiber has a noncircular cross-sectional shape.

26. A polarimeter comprising the optical fiber of claim 25.

27. A spectrum analyzer comprising the optical fiber of claim 25.

28. A polarization dependent optical delay line comprising the optical fiber of claim 25.

29. A device for stabilizing an optical amplifier pump laser, wherein the device comprises the optical fiber of claim 25.

30. An optical fiber comprising an endface with a non-spherical lens having a lens axis transverse to the longitudinal axis of the fiber, wherein the lens axis has a known orientation with respect to at least one of: (i) an outer surface, and (ii) a surface feature of, the fiber.

31. The optical fiber of claim 30, wherein the fiber is birefringent and comprises a waveguiding region with transverse polarization axes, and wherein the lens axis has a known orientation relative to at least one of the transverse polarization axes.

32. The optical fiber as in claim 31, wherein the lens axis is parallel to at least one of the transverse polarization axes.

33. An optical interconnection between two optical fibers with dissimilar cross-sectional shapes, comprising:
(a) a first fiber having a first optical core, a first effective diameter, and a first endface with an essentially round outer surface;
(b) a second fiber having a second optical core, a second effective diameter, and a second endface with a non-round outer surface; and
(c) an alignment fixture having at least one continuous surface, wherein the first effective diameter and the second effective diameter are not substantially equal, and when the first and second fibers are placed in the alignment fixture with their respective endfaces in abutting relationship in contact with the continuous surface, the first and second optical cores are in optical communication.

34. The optical interconnection of claim 32, wherein the second fiber comprises a conformal coating on the non-round outer surface.
